(19) United States
(12) Patent Application Publication
(10) Pub. No.: US 2010/0321292 A1
(43) Pub. Date: Dec. 23, 2010

(54) ELECTRONIC DEVICE AND OPERATING METHOD THEREOF

(75) Inventors: Rui Zhao, Shanghai City (CN); Xu-Dong Chen, Shanghai City (CN); Tony Tsai, Taipei (TW)

Correspondence Address: J C PATENTS, 4 VENTURE, SUITE 250, IRVINE, CA, 92618, US

(73) Assignee: INVENTEC APPLIANCES CORP., Taipei (TW)

(21) Appl. No.: 12/816,154

(22) Filed: Jun. 15, 2010

(30) Foreign Application Priority Data
Jun. 17, 2009 (TW) 98120247

(51) Int. Cl. G06F 3/033

(52) U.S. Cl. 345/157

(57) ABSTRACT

An electronic device and an operating method thereof are provided, wherein the electronic device includes a first infrared sensor and a display unit for displaying a frame. In the present operating method, an individual operation is defined for the first infrared sensor, wherein the individual operation is to turn the frame over or to move a position of a cursor displayed in the frame. If a period for which the first infrared sensor has sensed infrared radiation from an object is shorter than a first predetermined value, the first infrared sensor is determined as being temporarily hidden and the individual operation is performed.

### CROSS-REFERENCE TO RELATED APPLICATION

This application claims the priority benefit of Taiwan application serial no. 98120247, filed on Jun. 17, 2009. The entirety of the above-mentioned patent application is hereby incorporated by reference herein and made a part of specification.

### BACKGROUND OF THE INVENTION

1. Field of the Invention

The present invention generally relates to an electronic device and an operating method thereof, and more particularly, to an electronic device with an infrared sensor and an operating method thereof.

2. Description of Related Art

Electronic devices of different types and functions have been provided along with the rapid development of technologies. However, regardless of the type of an electronic device, the electronic device is usually operated by a user through physical buttons on the electronic device. Even though such button operation has been broadly accepted by users, a button may become invalid after being repeatedly pressed for a long time therefore cannot produce the desired result according to a user's action. Besides, because the physical buttons take up certain space, the size of the screen may have to be sacrificed or the size of the entire electronic device may have to be increased in order to dispose the physical buttons, which does not meet today's trend in the reduction of the size, thickness, and weight of the electronic device. In addition, a backlight module is usually disposed along with the buttons in an electronic device such that a user can operate the electronic device through the buttons at a dark place. However, the adoption of the backlight module increases the power consumption of the electronic device.

Touch screens have been disposed in more and more electronic devices instead of buttons. However, a screen may be scratched or even damaged regardless of whether a finger or a stylus is slid on the touch screen by the user, and the constant use of a stylus may cause incorrect direction or position identification of a touch screen. Moreover, the adoption of a touch screen greatly increases the hardware cost of an electronic device.

### SUMMARY OF THE INVENTION

Accordingly, the present invention is directed to an operating method of an electronic device, wherein a user is allowed to conveniently operate a frame or a cursor displayed by the electronic device.

The present invention is directed to an electronic device, wherein various operations on a frame or a cursor are realized by using low-cost infrared sensors.

The present invention provides an operating method of an electronic device, wherein the electronic device includes a display unit and a first infrared sensor, and the display unit is for displaying a frame. In the operating method, an individual operation for the first infrared sensor is first defined, wherein the individual operation is to turn the frame over or to move a position of a cursor displayed in the frame. When a period for which the first infrared sensor has sensed infrared radiation from an object is shorter than a first predetermined value, the first infrared sensor is determined as being temporarily hidden by the object and the individual operation is performed.

The present invention provides an electronic device including a frame content generating module, a display unit, a first infrared sensor, and a processing unit. The frame content generating module generates and provides a frame. The first infrared sensor is for sensing an infrared radiation. An individual operation is defined for the first infrared sensor, wherein the individual operation is to turn the frame over or to move a position of a cursor displayed in the frame. The processing unit is connected to the first infrared sensor, the frame content generating module, and the display unit. If a period for which the first infrared sensor has sensed infrared radiation from an object is shorter than a first predetermined value, the processing unit determines that the first infrared sensor is temporarily hidden by the object and performs the individual operation. The display unit displays the frame and presents the result of the individual operation.

As described above, in the present invention, the action of a user is sensed by an infrared sensor of an electronic device, and a corresponding operation is performed according to the type and target of the action. Thereby, a whole new operating experience is brought to the user.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of an electronic device according to an embodiment of the present invention.

FIG. 1B is a block diagram of an electronic device according to another embodiment of the present invention.

FIG. 2 is a flowchart of an operating method of an electronic device according to an embodiment of the present invention.

FIG. 3 is a layout diagram of infrared sensors according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

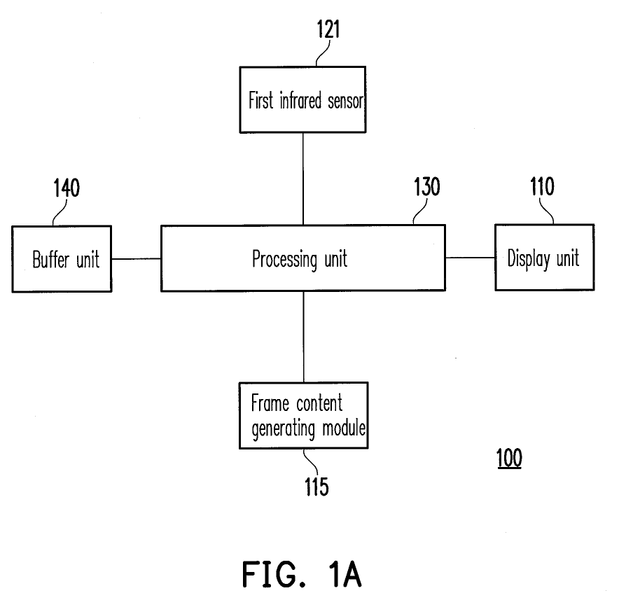

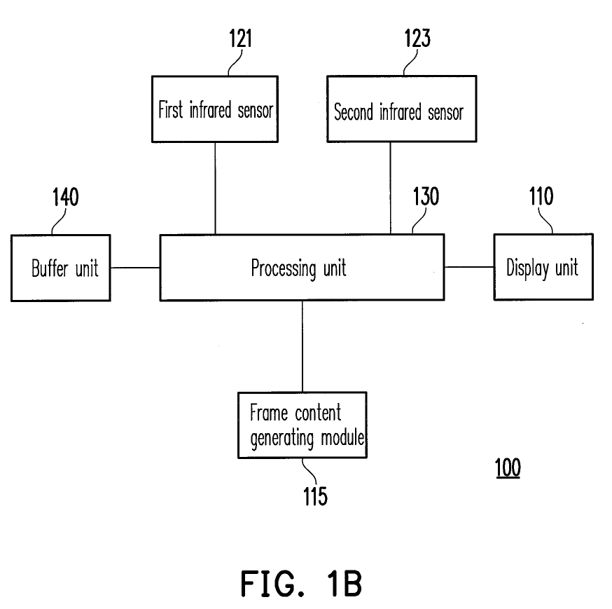

FIG. 1A is a block diagram of an electronic device according to an embodiment of the present invention. Referring to FIG. 1A, in the present embodiment, the electronic device 100 includes a display unit 110, a frame content generating module 115, a first infrared sensor 121, a processing unit 130, and a buffer unit 140. The electronic device 100 may be a cell phone, a personal digital assistant (PDA), a smart phone, or an e-book. However, the type of the electronic device 100 is not limited herein.

The frame content generating module 115 may be an operating system installed in the electronic device 100 or an application software executed by the electronic device 100. The frame content generating module 115 generates and provide a frame according to the function thereof. The display unit 110 may be a screen, a monitor or a display of the electronic device 100, for displaying the content of the frame to be viewed by a user. The frame may be the information, image, or frame displayed on the display unit 110, such as an operation image of an operating system, a user interface of an application software, or the content of a file presented by an application software. However, the content of the frame is not limited herein.

In the present embodiment, the first infrared sensor 121 is for sensing an infrared radiation. For example, the first infrared sensor 121 may be a passive infrared (PIR) sensor, which measures infrared light radiating from objects in its field of view. The first infrared sensor 121 may also be a thermographic camera (i.e the forward looking infrared (FUR) or the infrared camera).

An individual operation is defined for the first infrared sensor 121 of the electronic device 100, wherein the individual operation is to turn over the frame displayed by the display unit 110, or to move a position of a cursor displayed in the frame (the position of the cursor is called the cursor position for short). The first infrared sensor 121 senses an infrared radiation every time when the first infrared sensor 121 is hidden by an object (for example, the user covers the first infrared sensor 121 with his finger or other tools).

The processing unit 130 is respectively connected to the first infrared sensor 121, the display unit 110, and the frame content generating module 115. In the present embodiment, when a period for which the first infrared sensor 121 has sensed the infrared radiation from an object is shorter than a first predetermined value, the processing unit 130 determines that the first infrared sensor 121 is temporarily hidden by the object and performs the individual operation. To be specific, the processing unit 130 turns over the frame displayed by the display unit 110 or moves the position of the cursor displayed in the frame (for example, moves the cursor position displayed in the frame for one row), once in a predetermined direction. A user can view the result of the individual operation through the display unit 110.

Additionally, when the period is longer than or equal to the first predetermined value, the processing unit 130 determines that the first infrared sensor 121 is continually hidden by the object and the processing unit 130 continually performs the individual operation until the first infrared sensor 121 ceases to sense the infrared radiation. For example, the processing unit 130 continually turns over the frames displayed by the display unit 110 or continually moves the position of the cursor displayed in the frame (for example, continually moves the cursor position in the frame in unit of rows) in a predetermined direction until the first infrared sensor 121 ceases to sense the infrared radiation. Similarly, the user can view the result of the continually performed individual operation through the display unit 110.

FIG. 1B is a block diagram of an electronic device according to another embodiment of the present invention. In the present embodiment, the electronic device 100 further includes a second infrared sensor 123 besides the display unit 110, the frame content generating module 115, the first infrared sensor 121, the processing unit 130, and the buffer unit 140. In the embodiment, an individual operation for the first infrared sensor 121 and an individual operation for the second infrared sensor 123 are defined respectively, and a mutual operation for the first infrared sensor 121 and the second infrared sensor 123 is also defined. In which, the mutual operation is to turn the frame over or to move the position of the cursor displayed in the frame.

If the processing unit 130 determines that a time between determining the first infrared sensor 121 is temporarily hidden and determining the second infrared sensor 123 is temporarily hidden is shorter than a second predetermined value, the processing unit 130 performs the mutual operation for the first infrared sensor 121 and the second infrared sensor 123. For example, the processing unit 130 first determines an operation direction according to a disposition of the first infrared sensor 121 and the second infrared sensor 123 and the sequence in which the first infrared sensor 121 and the second infrared sensor 123 had been temporarily hidden respectively. Next, the processing unit 130 performs the mutual operation once in the operation direction.

However, if the processing unit 130 determines that the time between determining the first infrared sensor 121 is temporarily hidden and determining the second infrared sensor 123 is temporarily hidden is longer than or equal to the second predetermined value and shorter than a third predetermined value (wherein the third predetermined value is greater than the second predetermined value), the processing unit 130 repeatedly performs the mutual operation for the first infrared sensor 121 and second infrared sensor 123 which had been temporarily hidden until the infrared radiation is not sensed by the first infrared sensor 121 and second infrared sensor 123. In the present embodiment, the processing unit 130 determines an operation direction according to a disposition of the first infrared sensor 121 and the second infrared sensor 123 and the sequence in which the first infrared sensor 121 and the second infrared sensor 123 had been temporarily hidden respectively, and repeatedly performs the mutual operation in the operation direction until the infrared radiation is not sensed.

Additionally, when the time between determining that the first infrared sensor 121 is temporarily hidden and determining that the second infrared sensor 123 is temporarily hidden is longer than or equal to the third predetermined value, the processing unit 130 performs the individual operations for the first infrared sensor 121 which has been determined as temporarily hidden and performing the individual operation for the second infrared sensor 123 which has been determined as temporarily hidden.

In an embodiment, the individual operation or the mutual operation comprises dragging the frame for a predetermined range by the processing unit 130, wherein the predetermined range contains one or multiple rows in the frame. In another embodiment, the individual operation or the mutual operation comprises shifting the cursor to a next position (e.g. shifts the cursor position displayed in the frame for one grid), or shifting the cursor to a specific position by the processing unit 130, wherein the specific position may be the start position or the end position of the frame.

In the embodiments illustrated in FIG. 1A and FIG. 1B, the electronic device 100 determines which infrared sensor(s) the action of the user's finger is corresponding to and performs the operation corresponding to the hidden infrared sensor(s) according to the duration and trail of the action of the user's finger. Meanwhile, the electronic device 100 controls the frame content generating module 115 to obtain the corresponding operation result and stores the operation result into the buffer unit 140. In order to allow the user to view the operation result instantly, the frame content generating module 115 displays the operation result stored in the buffer unit 140 on the display unit 110 through the processing unit 130. In other words, the user can make the electronic device 100 to perform the corresponding operation and present the corresponding result by simply covering the infrared sensor(s) on the electronic device 100 with his finger (or other tools).

How the processing unit 130 determines the operation to be performed according to the action of the user's finger over the first infrared sensor 121 and/or the second infrared sensor 123 will be further described by taking the electronic device 100 illustrated in FIG. 1B as an example.

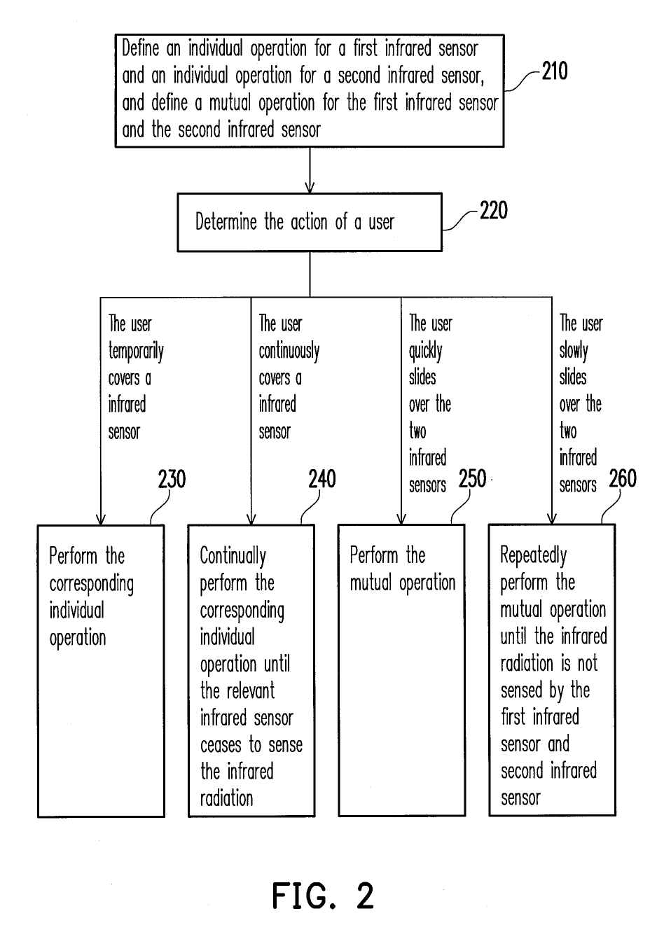

FIG. 2 is a flowchart of an operating method of an electronic device according to an embodiment of the present invention. Referring to both FIG. 1 and FIG. 2, first, in step 210, an individual operation for a first infrared sensor 121, an individual operation for a second infrared sensor 123, and a mutual operation for the first infrared sensor 121 and the second infrared sensor 123 are defined. In an embodiment, the individual operation may be a frame operation or a cursor operation, wherein the frame operation includes turning over a frame currently displayed on the display unit 110 of the electronic device 100, and the cursor operation includes moving a position of a cursor displayed in the frame. In another embodiment, the mutual operation may be a frame operation or a cursor operation. The frame operation includes scrolling a frame (i.e., the frame currently displayed on the display unit 110) to display the unseen content of the frame, dragging the frame for a predetermined range, and dragging the frame for a predetermined range and keeping the cursor position unchanged. The cursor operation includes moving the position of the cursor displayed in the frame for one grid, and moving the position of the cursor to a specific position of the frame currently displayed on the display unit 110. However, it should be mentioned that foregoing individual operations and mutual operations are only examples for describing the present invention, the contents of the individual operation and the mutual operation are not limited herein, and any operation related to a frame and a cursor can be defined as an individual operation or a mutual operation.

If the user is about to operate the electronic device 100 through the first infrared sensor 121 and/or the second infrared sensor 123, the user can cover a specific infrared sensor with his finger (or other tools) so that the specific infrared sensor can sense the infrared radiation caused by the user's finger (or a tool). Next, in step 220, the processing unit 130 determines which infrared sensor is corresponding to the action of the user and the type of the action.

When a period for which one of the infrared sensors (for example, the first infrared sensor 121) has sensed infrared radiation from the user's finger (or other tools) is shorter than a first predetermined value (for example, one second), the processing unit 130 determines that the first infrared sensor 121 is temporarily hidden by the user's finger (or other tools). Thus, in step 230, the processing unit 130 performs the individual operation for the first infrared sensor 121.

However, if the period for which one of the infrared sensors (for example, the second infrared sensor 123) has sensed infrared radiation from the user's finger (or other tools) is longer than or equal to the first predetermined value, the processing unit 130 determines that the second infrared sensor 123 is continually hidden by the user's finger (or other tools). In this case, in step 240, the processing unit 130 continually performs the individual operation for the second infrared sensor 123 until the second infrared sensor 123 ceases to sense the infrared radiation. Namely, if the user continually covers the second infrared sensor 123, the electronic device 100 continually perform the individual operation for the second infrared sensor 123 until the user moves his finger away.

Besides determining whether the user temporarily or continually covers any infrared sensor, the processing unit 130 also determines whether the user slides his finger from one infrared sensor to another infrared sensor. For example, if a time between determining that one of the infrared sensors (for example, the first infrared sensor 121) is temporarily hidden and determining that another infrared sensor (for example, the second infrared sensor 123) is temporarily hidden is shorter than a second predetermined value, the processing unit 130 determines that the user quickly slides his finger from the first infrared sensor 121 to the second infrared sensor 123. Thus, in step 250, the processing unit 130 performs the mutual operation for the two infrared sensors which had been temporarily hidden (i.e., the first infrared sensor 121 and the second infrared sensor 123).

If the time between determining that one of the infrared sensors (for example, the first infrared sensor 121) is temporarily hidden and determining that another infrared sensor (for example, the second infrared sensor 123) is temporarily hidden is longer than or equal to the second predetermined value and shorter than a third predetermined value (wherein the third predetermined value is greater than the second predetermined value), the processing unit 130 determines that the user slowly slides his finger over the two infrared sensors. Thus, in step 260, the processing unit 130 repeatedly performs the mutual operation for the two infrared sensors which had been temporarily hidden (i.e., the first infrared sensor 121 and the second infrared sensor 123) until the infrared radiation is not sensed by the first infrared sensor 121 and second infrared sensor 123.

It should be mentioned that when the time between determining that one of the infrared sensors (for example, the first infrared sensor 121) is temporarily hidden and determining that another infrared sensor (for example, the second infrared sensor 123) is temporarily hidden is longer than or equal to the third predetermined value (i.e., it takes too long time for the user to move his finger from one infrared sensor to another infrared sensor), the processing unit 130 performs the individual operations for the two infrared sensors which had been temporarily hidden (i.e., the first infrared sensor 121 and the second infrared sensor 123). Namely, in such a situation, the processing unit 130 determines that the user operates the two infrared sensors separately instead of sliding his finger from one infrared sensor to another infrared sensor.

In the present embodiment, the processing unit 130 determines the operation to be performed after the processing unit 130 determines the action performed by the user on the infrared sensor(s). When the processing unit 130 performs any individual operation or mutual operation, because the operation may change the frame or the cursor position, the processing unit 130 controls the frame content generating module 115 to obtain the corresponding operation result and stores the operation result into the buffer unit 140. After that, the frame content generating module 115 displays the operation result stored in the buffer unit 140 on the display unit 110 through the processing unit 130 so that the user can view the operation result through the display unit 110.

As described above, after the electronic device 100 is turned on, the first infrared sensor 121 and the second infrared sensor 123 of the electronic device 100 start to sense an infrared radiation from the user. Namely, the user can temporarily or continually cover the first infrared sensor 121 or the second infrared sensor 123 with his finger or quickly (or slowly) moves his finger between the two infrared sensors. After determining the action of the user's finger, the electronic device 100 performs the individual operation or mutual operation according to predetermined definitions. The user can conveniently operate the electronic device 100 thanks to the high sensitivity and high response speed of the infrared sensors.

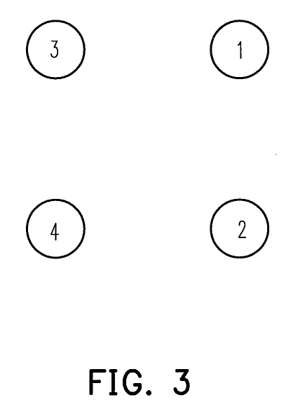

FIG. 3 is a layout diagram of infrared sensors according to an embodiment of the present invention. Referring to FIG. 3, in the present embodiment, the electronic device has an infrared sensor 1, an infrared sensor 2, an infrared sensor 3, and an infrared sensor 4. The four infrared sensors may be disposed on the same surface with the screen of the electronic device.

Four individual operations are respectively defined for the infrared sensor 1, the infrared sensor 2, the infrared sensor 3, and the infrared sensor 4, and each of the four infrared sensors is corresponding to a predetermined direction. Besides, a mutual operation is defined for every two of the four infrared sensors.

For example, the individual operations for the infrared sensor 1 and the infrared sensor 2 are both the frame operation for turning over the frame currently displayed by the electronic device, and the predetermined directions corresponding to the infrared sensor 1 and the infrared sensor 2 are respectively an upward direction and a downward direction. Thus, when the processing unit of the electronic device determines that the user temporarily covers the infrared sensor 1, the processing unit performs the frame operation once in the predetermined direction of the infrared sensor 1 (i.e., turns over the frame upwards once). When the processing unit determines that the user continually covers the infrared sensor 1, the processing unit continually turns over s the frames upwards until the user stops covering the infrared sensor 1. In addition, when the processing unit of the electronic device determines that the user temporarily covers the infrared sensor 2, the processing unit performs the frame operation once in the predetermined direction of the infrared sensor 2 (i.e., turns over the frame downwards once). When the processing unit determines that the user continually covers the infrared sensor 2, the processing unit continually turns over the frames downwards until the user moves his finger away.

For example, the individual operations for the infrared sensor 3 and the infrared sensor 4 are both for moving a position of a cursor displayed in the frame (for example, moving the cursor position for one row), and the predetermined directions corresponding to the infrared sensor 3 and the infrared sensor 4 are respectively an upward direction and a downward direction. Thus, when the processing unit of the electronic device determines that the user temporarily covers the infrared sensor 3, the processing unit moves the cursor position upwards for one row. If the user continually covers the infrared sensor 3 with his finger, the processing unit continually moves the cursor position upwards in unit of rows until the user moves his finger away. When the processing unit determines that the user temporarily covers the infrared sensor 4, the processing unit moves the cursor position downwards for one row. Similarly, when the processing unit determines that the user continually covers the infrared sensor 4, the processing unit continually moves the cursor position downwards in unit of rows until the user moves his finger away. It should be mentioned that in another embodiment, if no cursor is displayed in the frame currently displayed by the electronic device, the electronic device automatically scrolls the entire frame upwards or downwards in a uniform speed when the user covers the infrared sensor 3 or the infrared sensor 4.

Assuming that the mutual operation for the infrared sensor 1 and the infrared sensor 2 is for scrolling the frame currently displayed by the electronic device and displaying the unseen content of the frame, when the processing unit of the electronic device determines that the user quickly slides his finger from the infrared sensor 1 to the infrared sensor 2 (i.e., the time between determining that the infrared sensor 1 is temporarily hidden and determining that the infrared sensor 2 is temporarily hidden is shorter than a second predetermined value), the processing unit first determines an operation direction (in the present embodiment, the operation direction is a downward direction) according to a disposition of the infrared sensor 1 and the infrared sensor 2 and the sequence in which the infrared sensor 1 and the infrared sensor 2 had been temporarily hidden respectively. Then, the processing unit performs the corresponding mutual operation once in the operation direction (i.e., scrolls the frame downwards to display the part of the frame that is originally not displayed in the screen). If the processing unit determines that the user slowly slides his finger from the infrared sensor 1 to the infrared sensor 2 (i.e., the time between determining that the infrared sensor 1 is temporarily hidden and determining that the infrared sensor 2 is temporarily hidden is longer than or equal to the second predetermined value), the processing unit obtains the operation direction (i.e., a downward direction) of the user's finger through the method described above. After that, the processing unit repeatedly performs the corresponding operation in the operation direction until the infrared radiation is not sensed. As to the user, he can see that the frame is continually scrolled downwards and the part of the frame that is originally not shown in the screen is displayed. Contrarily, when the user quickly slides his finger from the infrared sensor 2 to the infrared sensor 1, the frame is scrolled upwards and the part of the frame that is originally not shown in the screen is displayed, and when the user slowly slides his finger from the infrared sensor 2 to the infrared sensor 1, the frame is continually scrolled upwards.

If the mutual operation for the infrared sensor 1 and the infrared sensor 3 is for moving the position of the cursor displayed in the frame displayed by the electronic device for one grid, when the processing unit of the electronic device determines that the user quickly slides his finger from the infrared sensor 1 to the infrared sensor 3, the processing unit determines an operation direction (i.e., a leftward direction) according to the disposition of the infrared sensor 1 and the infrared sensor 3 and the sequence in which the infrared sensor 1 and the infrared sensor 3 had been temporarily hidden respectively and moves the cursor position leftwards on the frame for one grid. If the user slowly slides his finger from the infrared sensor 1 to the infrared sensor 3, the processing unit continually moves the cursor position on the frame leftwards in unit of grids until the infrared radiation is not sensed. Contrarily, when the user quickly or slowly slides his finger from the infrared sensor 3 to the infrared sensor 1, the operation direction is a rightward direction. Thus, the cursor position is respectively moved rightwards for one grid or continually moved rightwards.

Assuming that the mutual operation for the infrared sensor 3 and the infrared sensor 4 is for dragging the currently displayed frame for a predetermined range and keeping the cursor position unchanged, when the user quickly slides his finger from the infrared sensor 3 to the infrared sensor 4, since the operation direction is a downward direction, the frame is moved downwards once for the predetermined range and the cursor position is kept unchanged. When the user slowly slides his finger from the infrared sensor 3 to the infrared sensor 4, the frame is slowly moved downwards in unit of the predetermined range until the infrared radiation is not sensed anymore, and the cursor position is kept unchanged. In the present embodiment, the predetermined range may be one or multiple rows in the frame. However, the present invention is not limited thereto. In addition, when the user quickly slides his finger from the infrared sensor 4 to the infrared sensor 3, the frame is moved upwards for the predetermined range once, and the cursor position is kept unchanged, and when the user slowly slides his finger from the infrared sensor 4 to the infrared sensor 3, the frame is continually moved upwards for the predetermined range, and the cursor position is kept unchanged.

If the mutual operation for the infrared sensor 2 and the infrared sensor 4 is for dragging the currently displayed frame for the predetermined range, when the processing unit of the electronic device determines that the user quickly slides his finger from the infrared sensor 2 to the infrared sensor 4, the currently displayed frame is dragged leftwards for the predetermined range, and when the processing unit determines that the user's finger slowly slides from the infrared sensor 2 to the infrared sensor 4, the frame is continually dragged leftwards. Contrarily, when the user quickly slides his finger from the infrared sensor 4 to the infrared sensor 2, the currently displayed frame is dragged rightwards for the predetermined range, and when the user slowly slides his finger from the infrared sensor 4 to the infrared sensor 2, the frame is continually dragged rightwards.

In an embodiment, the mutual operation for the infrared sensor 2 and the infrared sensor 3 is for moving the cursor position on the frame of the electronic device to a specific position of the frame, wherein the specific position is the start position of the frame. When the user quickly slides his finger from the infrared sensor 3 to the infrared sensor 2, the cursor position is moved to the start position of the frame. In another embodiment, the mutual operation corresponding to the infrared sensor 1 and the infrared sensor 4 is for moving the cursor position displayed on the frame to another specific position of the frame (for example, the end position of the frame). Thus, when the user quickly slides his finger from the infrared sensor 1 to the infrared sensor 4, the cursor position is moved to the end position of the frame.

It should be noted that the individual operation for each infrared sensor and the mutual operation for every two infrared sensors are only examples for describing the present invention, and the contents of the individual operations and the mutual operations are not limited in the present invention.

As described above, the present invention provides an electronic device and an operating method thereof, wherein infrared sensors with high sensitivity are adopted for sensing the actions performed by a user on the infrared sensors, and corresponding frame and cursor operations are performed. By operating the electronic device with infrared sensors that take little space, the electronic device is kept small and slim, and the power consumption thereof is reduced to meet today's trend of energy conservation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operating method of an electronic device, the electronic device comprising a first infrared sensor and a display unit for displaying a frame, and the operating method comprising:
defining an individual operation for the first infrared sensor, wherein the individual operation is to turn the frame over or to move a position of a cursor displayed in the frame; and
if a period for which the first infrared sensor has sensed infrared radiation from an object is shorter than a first predetermined value, determining that the first infrared sensor is temporarily hidden by the object, and performing the individual operation.

2. The operating method according to claim 1 further comprising:
if the period is longer than or equal to the first predetermined value, determining that the first infrared sensor is continually hidden by the object, and continually performing the individual operation until the first infrared sensor ceases to sense the infrared radiation.

3. The operating method according to claim 2, wherein the step of continually performing the individual operation until the first infrared sensor ceases to sense the infrared radiation comprises:
continually turning over the frames, or continually moving the position of the cursor, in a predetermined direction until the first infrared sensor ceases to sense the infrared radiation.

4. The operating method according to claim 1, wherein the step of performing the individual operation comprises:
turning over the frame, or moving the position of the cursor, once in a predetermined direction.

5. The operating method according to claim 1, wherein the electronic device further comprises a second infrared sensor, and the operating method further comprises:
defining a mutual operation for the first infrared sensor and the second infrared sensor, wherein the mutual operation is to turn the frame over or to move the position of the cursor displayed in the frame; and
if a time between determining that the first infrared sensor is temporarily hidden and determining that the second infrared sensor is temporarily hidden is shorter than a second predetermined value, performing the mutual operation.

6. The operating method according to claim 5, wherein the step of performing the mutual operation comprises:
determining an operation direction according to a disposition of the first infrared sensor and the second infrared sensor, and a sequence in which the first infrared sensor and the second infrared sensor had been temporarily hidden respectively; and
performing the mutual operation once in the operation direction.

7. The operating method according to claim 5 further comprising:
if the time between determining that the first infrared sensor is temporarily hidden and determining that the second infrared sensor is temporarily hidden is longer than or equal to the second predetermined value and shorter than a third predetermined value, repeatedly performing the mutual operation for the first infrared sensor and second infrared sensor which had been temporarily hidden until the infrared radiation is not sensed by the first infrared sensor and second infrared sensor, and wherein the third predetermined value is greater than the second predetermined value.

8. The operating method according to claim 7, wherein the step of repeatedly performing the mutual operation for the first infrared sensor and second infrared sensor which had been temporarily hidden until the infrared radiation is not sensed comprises:
determining an operation direction according to a disposition of the first infrared sensor and the second infrared sensor, and a sequence in which the first infrared sensor and the second infrared sensor had been temporarily hidden respectively; and
repeatedly performing the mutual operation in the operation direction until the infrared radiation is not sensed.

9. The operating method according to claim 7 further comprising:
if the time between determining that the first infrared sensor is temporarily hidden and determining that the second infrared sensor is temporarily hidden is longer than or equal to the third predetermined value, performing the individual operation for the first infrared sensor which had been temporarily hidden and performing the individual operation for the second infrared sensor which had been temporarily hidden.

10. The operating method according to claim 5, wherein the individual operation or the mutual operation comprises dragging the frame for a predetermined range, shifting the cursor to a next position, or shifting the cursor to a specific position.

11. An electronic device, comprising:
a frame content generating module, for generating and providing a frame;
a first infrared sensor, for sensing an infrared radiation, wherein an individual operation is defined for the first infrared sensor, and the individual operation is to turn the frame over or to move a position of a cursor displayed in the frame;
a processing unit, coupled to the first infrared sensor and the frame content generating module, wherein if a period for which the first infrared sensor has sensed infrared radiation from an object is shorter than a first predetermined value, the processing unit determines that the first infrared sensor is temporarily hidden by the object and performs the individual operation; and
a display unit, coupled to the processing unit, for displaying the frame and presenting a result of the individual operation.

12. The electronic device according to claim 11, wherein if the first infrared sensor determines that the period is longer than or equal to the first predetermined value, the processing unit determines that the first infrared sensor is continually hidden by the object and continually performs the individual operation until the first infrared sensor ceases to sense the infrared radiation.

13. The electronic device according to claim 12, wherein the processing unit continually turns over the frames, or continually moves the position of the cursor, in a predetermined direction until the first infrared sensor ceases to sense the infrared radiation.

14. The electronic device according to claim 11, wherein the processing unit turns over the frame or moves the position of the cursor, once in a predetermined direction.

15. The electronic device according to claim 11 further comprising:
a second infrared sensor, coupled to the processing unit, wherein a mutual operation is defined for the second infrared sensor and the first infrared sensor, and the mutual operation is to turn the frame over or to move the position of the cursor displayed in the frame,
wherein if the processing unit determines that a time between determining the first infrared sensor is temporarily hidden and determining the second infrared sensor is temporarily hidden is shorter than a second predetermined value, the processing unit performs the mutual operation.

16. The electronic device according to claim 15, wherein the processing unit determines an operation direction according to a disposition of the first infrared sensor and the second infrared sensor, and a sequence in which the first infrared sensor and the second infrared sensor had been temporarily hidden respectively, and the processing unit performs the mutual operation once in the operation direction.

17. The electronic device according to claim 15, wherein if the processing unit determines that the time between determining the first infrared sensor is temporarily hidden and determining the second infrared sensor is temporarily hidden is longer than or equal to the second predetermined value and shorter than a third predetermined value, the processing unit repeatedly performs the mutual operation for the first infrared sensor and second infrared sensor which has been temporarily hidden until the infrared radiation is not sensed by the first infrared sensor and second infrared sensor, and wherein the third predetermined value is greater than the second predetermined value.

18. The electronic device according to claim 17, wherein the processing unit determines an operation direction according to a disposition of the first infrared sensor and the second infrared sensor, and a sequence in which the first infrared sensor and the second infrared sensor had been temporarily hidden respectively, and the processing unit repeatedly performs the mutual operation in the operation direction until the infrared radiation is not sensed.

19. The electronic device according to claim 17, wherein if the processing unit determines that the time between determining that the first infrared sensor is temporarily hidden and determining that the second infrared sensor is temporarily hidden is longer than or equal to the third predetermined value, the processing unit performs the individual operation for the first infrared sensor which had been temporarily hidden and performs the individual operation for the second infrared sensor which had been temporarily hidden.

20. The electronic device according to claim 15, wherein the individual operation or the mutual operation comprises dragging the frame for a predetermined range, shifting the cursor to a next position, or shifting the cursor to a specific position.
